(19) United States
(12) Patent Application Publication
(10) Pub. No.: US 2010/0049894 A1
(43) Pub. Date: Feb. 25, 2010

(54) DATA BACKUP TRANSMITTER

(76) Inventor: CHEN-CHE LIN, KEELUNG CITY (TW)

Correspondence Address: Kile Goekjian Reed & McManus PLLC, 1200 New Hampshire Ave, NW, Suite 570, Washington, DC, 20036, US

(21) Appl. No.: 12/544,203

(22) Filed: Aug. 19, 2009

(30) Foreign Application Priority Data
Aug. 22, 2008 (TW) 97215109

(51) Int. Cl. G06F 13/14

(52) U.S. Cl. 710/305

(57) ABSTRACT

A data backup transmitter includes a body, a first connecting port and a second connecting port. The first and the second connecting ports are connected to the body. A data backup assembly is electrically connected between the first and the second connecting ports. The data backup assembly has a backup chip for controlling a backup process between the first and the second connecting ports. Thus, the first and second connecting ports are inserted into a computing device and a data-transmitting carrier respectively. A control button is used to control the backup chip to execute the signal transmission and data backup between the computing device and the data-transmitting carrier.

### BACKGROUND OF THE INVENTION

1. Field of the Invention

The present invention relates to a transmitter, and in particular, to a data backup transmitter which is connected between a computing device and a data-transmitting carrier for signal transmission and data backup by means of a data backup assembly.

2. Description of Related Art

In the current society, computer has been a very popular communication apparatus. As for the high-tech industry, manufacturing industry, financial industry or government organizations, the computer has become an indispensible tool. Further, it is important to install an operating system (such as Windows) in a computer, so that people can use the computer to edit documents, play audio/video multi-media, control automatic systems or surf the Internet. Especially, the Internet is a popular means whereby people can transmit and/or receive data. It is well known that viruses may attack the computer and the operation system in the computer after surfing the Internet. As a result, the data stored in the computer may be damaged seriously. On the other hand, due to men-made mistakes, the documents or data stored in the computer may be lost. Even, the normal function of the operating system may be seriously affected.

Therefore, it is important to backup the data stored in a data storage device such as a computer or hard disk, thereby protecting the data therein against viruses or men-made mistakes. However, it is necessary for the computer, hard disk or other portable storage devices to be provided with backup software or hardware, whereby the user can backup the data smoothly. Furthermore, the user has to be familiar with the backup process of the computer system.

If the hard disk or other portable storage device is not provided with backup software or hardware, and the user is not familiar with the backup process, it would be difficult and inconvenient to backup the data.

In order to overcome the above problems existed in the conventional backup process, the present Inventor proposes a novel and reasonable structure based on his delicate researches and expert experiences.

### SUMMARY OF THE INVENTION

The objective of the present invention is to provide a data backup transmitter, which is capable of executing data transmission and data backup between a computing device and a data-transmitting carrier. A data backup assembly is provided between a first connecting port and a second connecting port. The data backup structure utilizes a backup chip to execute the data backup between the computing device and any kind of the data-transmitting carriers. Further, a control button is used to control the data backup process. Thus, the user can backup the data for different data-transmitting carriers and computing devices.

Another objective of the present invention lies in that: even though the data-transmitting carrier is not provided with backup software or hardware, or the user is not familiar with the backup process of a computing device (such as a computer system), the user can still execute the data backup and data transmission between the computing device and the data-transmitting carrier because the operation of the data backup assembly is easy.

The present invention provides a data backup transmitter, which includes a body, a first connecting port, a second connecting port, and a data backup assembly. The first connecting port is connected to the body, and the second connecting port is connected to the body. The data backup assembly is electrically connected between the first connecting port and the second connecting port. The data backup assembly has a circuit board and a backup chip provided on the circuit board. The first connecting port and the second connecting port are electrically connected on the circuit board. The backup chip controls the backup process between the first connecting port and the second connecting port.

In order to further understand the characteristics and technical contents of the present invention, a description relating thereto will be made with reference to the accompanying drawings. However, the drawings are illustrative only but not used to limit the present invention.

### BRIEF DESCRIPTION OF THE DRAWINGS

FIG. 1 is a perspective view showing the data backup transmitter according to the first embodiment of the present invention;

FIG. 2 is a cross-sectional view showing the interior of the body of the data backup transmitter according to the first embodiment of the present invention;

FIG. 3 is a perspective view showing the data backup transmitter according to the second embodiment of the present invention; and

FIG. 4 is a perspective view showing the data backup transmitter according to the third embodiment of the present invention.

### DETAILED DESCRIPTION OF THE PREFERRED EMBODIMENTS

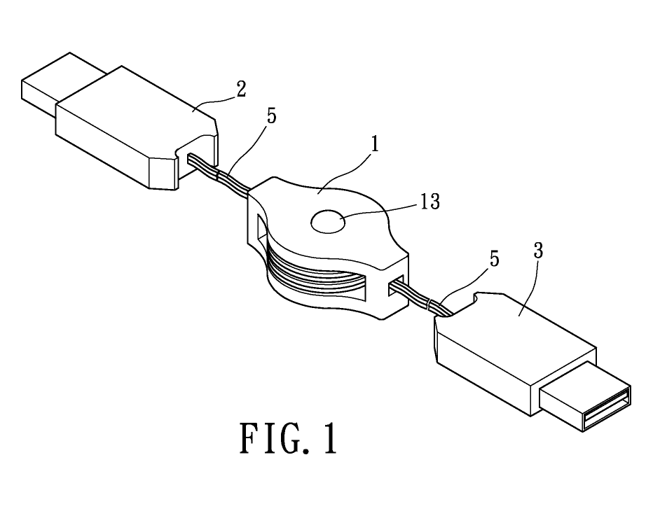

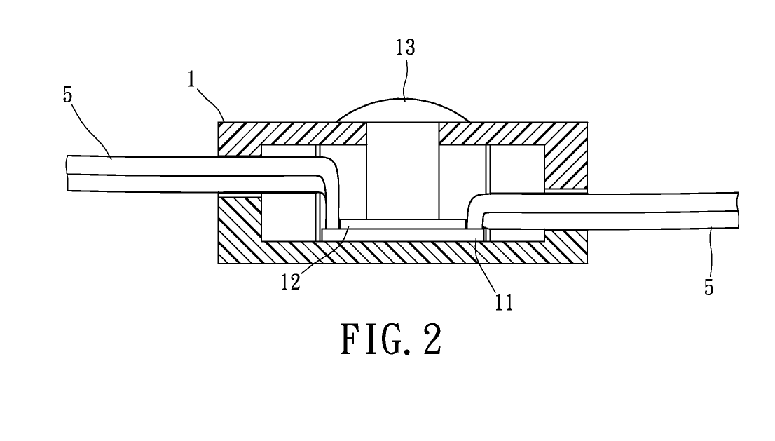

Please refer to FIGS. 1 and 2, which show the data backup transmitter according to the first embodiment of the present invention. In the present embodiment, the data backup transmitter is a line-winding assembly, which includes a body 1, a first connecting port 2 and a second connecting port 3.

The body 1 is a reel for winding a transmitting line 5, whereby the first connecting port 2 and the third connecting port 3 can be retracted or extended with respect to the reel. As shown in FIG. 2, in the present embodiment, the interior of the body 1 has a circuit board 11, a backup chip 12 and a control button 13. The circuit board 11, the backup chip 12 and the control button 13 constitute a data backup assembly. The backup chip 12 is electrically connected to the circuit board 11 for reading documental data and executing a backup process thereof. The control button 13 is electrically connected to the circuit board 1 for controlling the operation of the backup chip 12.

The first connecting port 2 is a connector, which can be retractably connected to one side of the body 1 by means of the body 1 and the transmitting line 5. The first connecting port 2 is electrically connected to the circuit board 11 (FIG. 2) and thus it is used as a transmitting medium for a computing device (not shown). The first connecting port 2 can be inserted into the computing device for data transmission.

The second connecting port 3 is a connector, which can be retractably connected to another side of the body 1 by means of the body 1 and the transmission line 5. The second connecting port 3 is electrically connected to the circuit board 11 (FIG. 2) and thus it is used as a transmitting medium for a data-transmitting carrier (not shown). The second connecting port 3 can be inserted into any kind of data-transmitting carriers for data transmission.

In the present invention, each of the first connecting port 2 and the second connecting port 3 can be a connecting port of USB standard or a connector suitable for the standard of the computing device and the data-transmitting carrier. In the present invention, the computing device and the data-transmitting carrier may by a mobile phone, a desktop computer, a notebook computer, a flat panel computer, a handheld computer, a personal digital assistant, or any electronic storage device.

With this arrangement, when the data backup transmitter is in use, the first connecting port 2 and the second connecting port 3 are inserted into the computing device and the data-transmitting carrier respectively. The backup chip is processed to make a screen of the computing device to display a backup function. After the user chooses the data for backup, the data after backup is transmitted to the data-transmitting carrier to generate mutual transmission of data. Alternatively, with the control button 13, the user controls the backup chip 12 to execute the mutual data backup between the computing device and the data-transmission carrier. Thus, no matter whether the computer device or the data-transmitting carrier has a data backup function, the user can transmit signals and backup the data smoothly even though he/she is not familiar with the data backup process of the computer system.

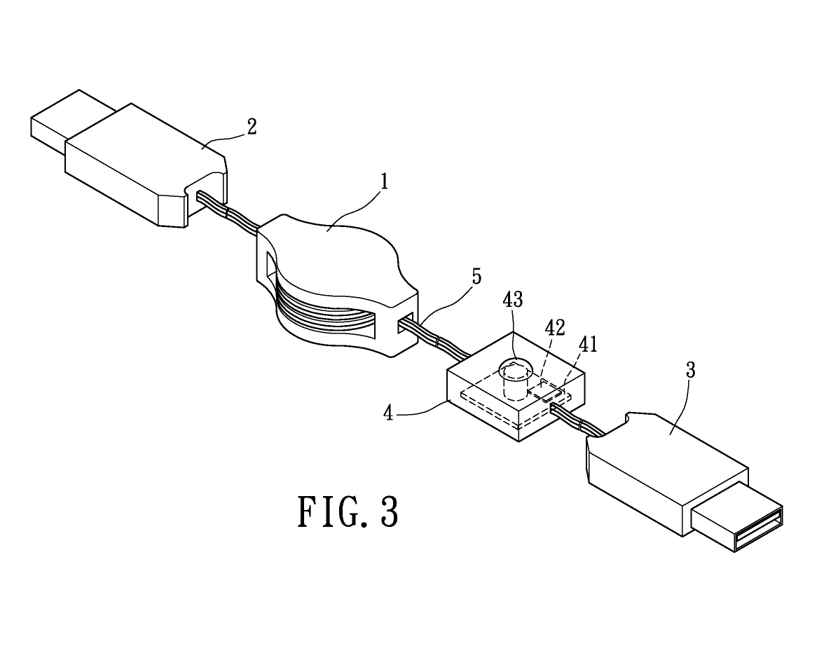

Please refer to FIG. 3, which shows the data backup transmitter according to the second embodiment of the present invention. The data backup transmitter includes a body 1, a first connecting port 2, a second connecting port 3 and a data backup assembly 4.

The difference between the second embodiment and the first embodiment lies in that: the data backup assembly 4 is an independent component that is electrically connected between the first connecting port 2 and the second connecting port 3. The data backup assembly 4 has a circuit board 41, a backup chip 42 and a control button 43. The circuit board 41 is electrically connected to the first transmission line 2 and the second transmission line 3 for data transmission. The backup chip 42 is electrically connected to the circuit board 41 to backup the data between the computing device and the data-transmitting carrier. The control button 43 is electrically connected on the circuit board 41 for controlling the backup chip 42 and executing the backup process between the computing device and the data-transmitting carrier. Thus, when the first connecting port 2 and the second connecting port 3 are inserted into the computing device and the data-transmitting carrier, the data backup assembly 4 can execute the signal transmission and data backup between the computing device and the data-transmitting carrier.

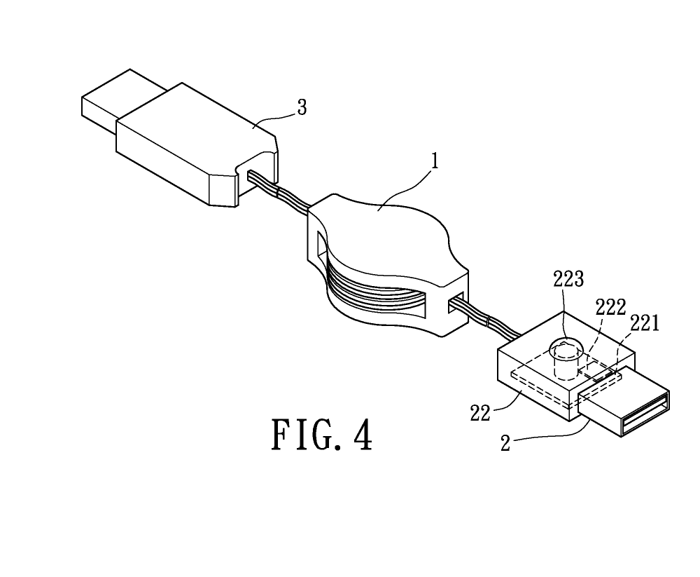

Please refer to FIG. 4, which shows the data backup transmitter according to the third embodiment of the present invention. The data backup transmitter includes a body 1, a first connecting port 2, and a second connecting port 3.

The difference between the third embodiment and the first embodiment lies in that: the first connecting port 2 is provided with a data backup assembly 22. The data backup assembly 22 has a circuit board 221, a backup chip 222 and a control button 223. The backup chip 222 is electrically connected to the circuit board 221. The control button 223 is electrically connected to the circuit board 221 for controlling the backup chip 222 and executing the signal transmission and the data backup between the computing device and the data-transmitting carrier.

In the above embodiments of the present invention, the control button of the data backup assembly is not a necessary component, so that the control button can be omitted according to the practice demands.

According to the above, with the data backup assembly, the data backup transmitter of the present invention has advantageous features as follows:

(1) With the backup chip in the data backup assembly, the data backup process between the computing device and the data-transmitting carrier can be executed efficiently. Thus, the user can execute the data backup process for different data-transmitting carriers.

(2) Even though the data-transmitting carrier is not provided with data backup software or hardware, the user can still execute the data backup and data transmission between the computing device and the data-transmitting carrier because the operation of the data backup assembly is easy.

(3) Even though the user is not familiar with the data backup process of the computer system, the user can still execute the data backup and signal transmission between the computing device and the data-transmitting carrier because the operation of the data backup assembly is easy

The above-mentioned descriptions represent merely the preferred embodiments of the present invention, without any intention to limit the scope of the present invention thereto. Various equivalent changes, alternations or modifications based on the claims of present invention are all consequently viewed as being embraced by the scope of the present invention.

What is claimed is:

1. A data backup transmitter, comprising:
a body;
a first connecting port connected to the body;
a second connecting port connected to the body; and
a data backup assembly electrically connected between the first connecting port and the second connecting port, the data backup assembly having a circuit board and a backup chip provided on the circuit board, the first connecting port and the second connecting port being electrically connected on the circuit board, the backup chip controlling a backup process between the first connecting port and the second connecting port.

2. The data backup transmitter according to claim 1, wherein the data backup assembly is provided in the body.

3. The data backup transmitter according to claim 1, wherein the data backup assembly is provided between the body and the first connecting port.

4. The data backup transmitter according to claim 1, wherein the data backup assembly is provided between the body and the second connecting port.

5. The data backup transmitter according to claim 1, wherein the data backup assembly is provided with the first connecting port or the second connecting port.

6. The data backup transmitter according to claim 1, wherein the data backup assembly has a control button electrically connected on the circuit board for controlling the backup chip.

7. The data backup transmitter according to claim 1, wherein the data backup transmitter is a line-winding assembly and the body is a reel, the first connecting port and the second connecting port are retractably connected to the reel with a transmission line respectively.

8. The data backup transmitter according to claim 1, wherein each of the first connecting port and the second connecting port is a connector of USB standard.
